(19) United States
(12) Patent Application Publication
(10) Pub. No.: US 2008/0244061 A1
(43) Pub. Date: Oct. 2, 2008

(54) METHOD FOR MANAGING RESOURCES

(75) Inventor: Gregory C. Kime, Logan, UT (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/694,364

(22) Filed: Mar. 30, 2007

(51) Int. Cl. G06F 15/173

(52) U.S. Cl. 709/224; 709/226

(57) ABSTRACT

The present disclosure provides a method for managing resources. According to one exemplary embodiment, the method may include establishing a resources threshold, the resources threshold indicative of a maximum level of recommended resource consumption for a particular client. The method may further include monitoring a level of activity at the client and notifying the client if the level of activity is approaching the resources threshold. Of course, additional embodiments, variations and modifications are possible without departing from this embodiment.

### FIELD

The present disclosure describes a method for monitoring and managing the consumption of resources.

### BACKGROUND

Unfortunately, network resources within a given corporation or business entity are being consumed at an excessive rate and in many instances are consumed up to their total capacity. It is often difficult for these companies to monitor their employees' personal usage of corporate networks. Therefore, it may be beneficial for companies to minimize the amount of non-work-related resources consumed by their employees, as it may have a negative affect upon costs as well as worker productivity.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a diagram of a system in accordance with one exemplary embodiment of the present disclosure;

FIG. 2 is a diagram showing another exemplary embodiment depicting operations in accordance with the present disclosure; and

FIG. 3 is a diagram showing yet another exemplary embodiment depicting operations in accordance with the present disclosure.

Although the following Detailed Description will proceed with reference being made to illustrative embodiments, many alternatives, modifications, and variations thereof will be apparent to those skilled in the art.

### DETAILED DESCRIPTION

Some companies are able to manage resources (e.g., internet bandwidth, network bandwidth, etc.) through the utilization of a number of tools that support bandwidth management, destination management and other network related controls. In particular, internet bandwidth consumption involving non-work related activities is increasingly problematic for many companies. Therefore, an effective technique for reducing the non-work related network consumption of employees is needed. Therefore, both employers and employees need to determine what constitutes an acceptable amount of consumed resources.

Generally, this disclosure provides a system and method for managing resources. The methods described herein may be used by employers to reduce and/or alter the overall network consumption by their employee base. Implementation of these methods may result in significant cost savings by reducing the amount of bandwidth consumed and also by encouraging employees to minimize their non-work related activities at the workplace. In some embodiments, this disclosure may include a client or server based application that allows an employer to promote desirable network utilization behavior.

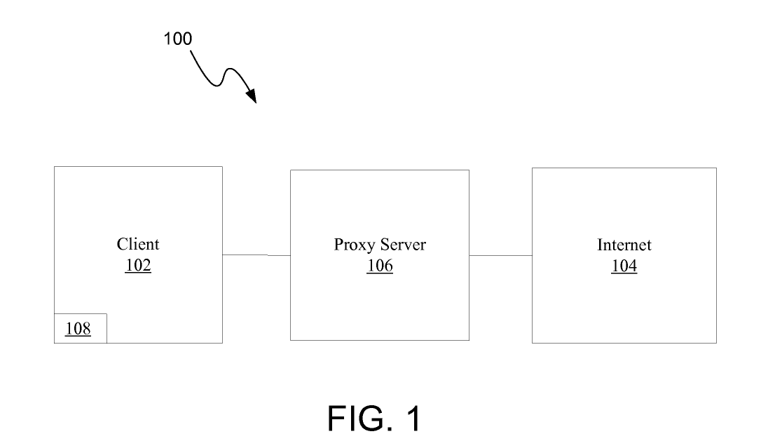

Referring now to FIG. 1, an exemplary embodiment of a system 100 for managing resources is shown. System 100 may include client 102 connected to the Internet 104 through proxy server 106. Client 102 may include an indicator 108 configured to provide an indication as to the user's current resource consumption level. Indicator 108 may further include data pertaining to that particular user's maximum threshold consumption level. In some embodiments, indicator 108 may be located on or adjacent to the computer screen of the user's client 102. For example, a user may have a certain resources limit or average which is in his/her profile. As that bandwidth is approached, indicator 108 may include a light that may transition from green to yellow. Once the resources threshold is met and/or exceeded the indicator light 108 may change from yellow to red. Indicator 108 may transition back to yellow and then green if the high bandwidth activity is suspended or decreased. In some embodiments, the presence of indicator 108 may allow the user to identify a problem with their current over utilization of non-work related resources. Indicator 108 may notify the user of nonconformance with company policies (i.e., approaching or exceeding a maximum threshold consumption level). Of course, various other indicators may be used in addition to the indicator lights described above in the present embodiment. For example, if the resources threshold has been exceeded an alert may be generated and delivered to the user's client via email or other methods.

In some embodiments, the user individually, or the group as a whole may be measured in their ability to reduce the amount of bandwidth they consume. A profile may be established for each user indicating the type of internet activity that is permitted. For example, a user in a particular group may be permitted to access certain websites without negatively affecting their current resources consumption level (i.e., without approaching their individual threshold level). Once this profile is established for each work type, the user's internet consumption may be monitored (e.g., administrator, etc.) and as they exceed their particular threshold, an indication may be provided showing that they are lowering the performance of their group via indicator 108, which may or may not be associated with client 102. For example, if an employee exceeds their resources threshold, system 100 may be configured to impart a penalty, thus reducing the amount of resources available to the employee in the future. This may be applied to the group as well.

In some embodiments, an individual user's profile may be created so as to correspond with his/her group's targeted usage. Further, if there are changes in the user's particular job description or work function the filter/application may allow the user to tune their settings, requesting more or less resources for their work. In some embodiments, the user may request additional bandwidth from the employer and/or internet provider once his/her threshold level has been reached. This may be implemented across a variety of domains including network and platform (e.g., if a user was only using 10% of a virtualized platform, the remaining 90% may be used for other resources).

In some embodiments, the methods described herein may be used to perform security management for the network. Individual users and their corresponding groups may monitor security management data, which may include standard behavior (e.g., browsing patterns) that may be typical or expected from that particular entity. For example, a particular user or group may require access to certain websites during the normal course of business operations. These internet browsing patterns may be recorded and measured. Any deviation from this behavior may be reported to the user and/or to the network management system. This information may be used by the company to assist in identifying clients that are being abused by a third party.

In some embodiments, certain areas of the network may not be able to provide the requested level of performance. For example, in a Quality of Service (QoS) system, QoS administrators may be responsible for implementing a QoS queuing architecture by defining the scheduler profiles and referencing them from QoS profiles. QoS administrators may also configure parameter definitions that control the parameters, interfaces, and ranges of values that QoS clients, using QoS parameters, can assign. In contrast, QoS clients may be responsible for configuring services for individual subscribers by creating parameter instances. The parameter instances that QoS clients create may depend on the settings that the QoS administrator defined in parameter definitions. QoS clients may manage these services using a variety of different tools, including, but not limited to, command line interface (CLI), Service Deployment System (SDX), IP multicast bandwidth adjustment, and/or RADIUS.

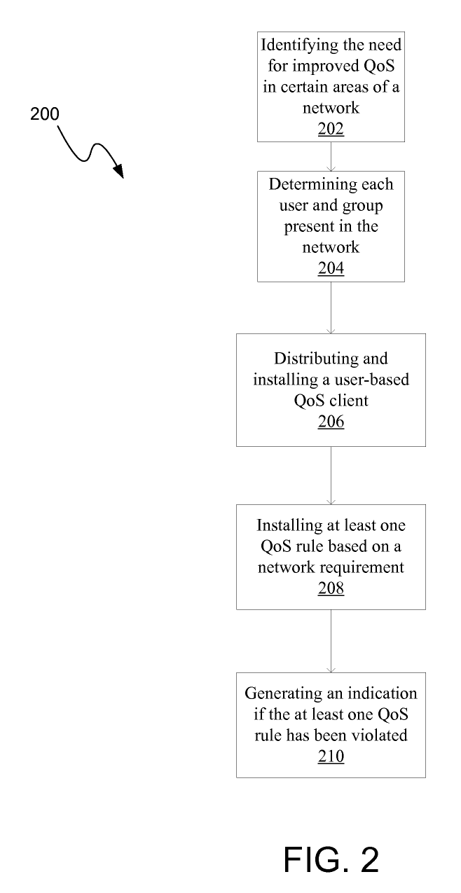

Referring now to FIG. 2, an exemplary embodiment of a flowchart 200 showing exemplary operations for managing resources is provided. Operations may include identifying the need for improved QoS in certain areas of the network (202). Operations 200 may also include determining each user and group present in the network (204). Operations 200 may additionally include distributing and installing a user based QoS client (206). Operations 200 may further include installing QoS rules based upon the network requirements (208). Operations may also include generating an indication if the at least one QoS rule has been violated (210). Of course additional operations are also within the scope of the present disclosure.

The QoS rules, as described herein, may include information regarding traffic rate, volume, time of day, approved websites, etc. As a result, the QoS client may award good behavior based upon the QoS rules. For example, these incentives may be based on various calculations regarding the average and median resource consumption by each user and group. As mentioned above, certain destinations on the Internet may be exempt from the calculations. This incentive structure may result in an overall reduction of consumed bandwidth, thus reducing costs and increasing worker productivity.

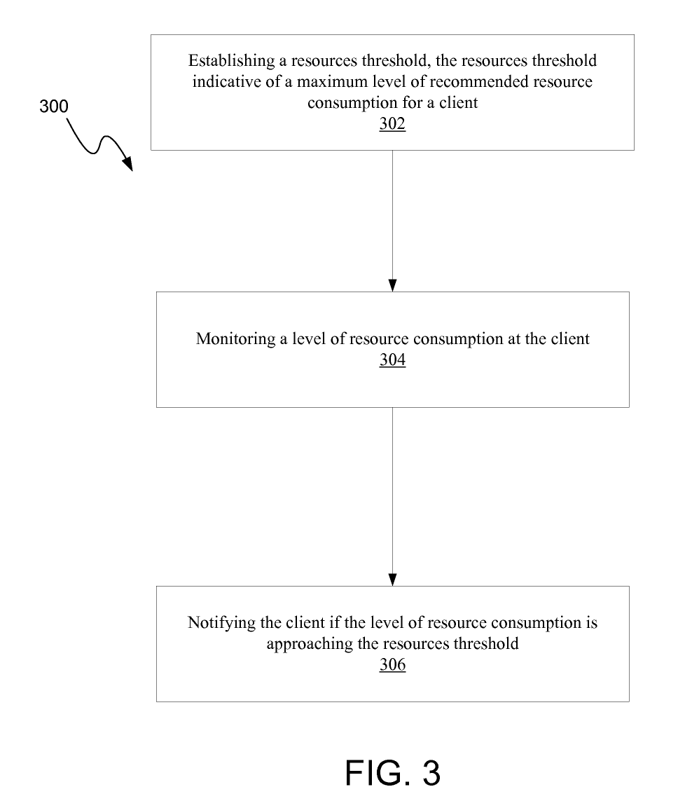

FIG. 3 depicts another flowchart 300 of exemplary operations consistent with the present disclosure. Operations may include establishing a resources threshold, the internet resources threshold indicative of a maximum level of recommended resource consumption for a particular client (302). Operations may further include monitoring a level of resource consumption at a client (304). Operations may also include notifying the client if the level of resource consumption is approaching the resources threshold (306). Of course additional operations are also within the scope of the present disclosure. It should be understood that any of the operations and/or operative components described in any embodiment herein may be implemented in software, firmware, hardwired circuitry and/or any combination thereof.

Embodiments of the methods described above may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic operations. Other embodiments may be implemented as software modules executed by a programmable control device.

Accordingly, at least one embodiment described herein may provide a method for managing resources. The method may include establishing a resources threshold, the resources threshold indicative of a maximum level of recommended resource consumption for a particular client. The method may further include monitoring a level of resource consumption at a client and notifying the client if the level of resource consumption is approaching the resources threshold.

The embodiments described herein may provide numerous advantages over the prior art. For example, some embodiments may be used to notify users of excessive bandwidth consumption. This disclosure also provides a method for evaluating possible security related information in order to identify clients that may be abused or infected by a third party.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A method comprising:
establishing a resources threshold, the resources threshold indicative of a maximum level of recommended resource consumption for a client;
monitoring a level of resource consumption at the client; and
notifying the client if the level of resource consumption is approaching the resources threshold.

2. The method according to claim 1, wherein notifying the client is performed via an indicator associated with the client.

3. The method according to claim 1, further comprising generating an alert if the level of resource consumption exceeds the resources threshold.

4. The method according to claim 1, further comprising creating a profile for the client, the profile including security management data.

5. The method according to claim 1, further comprising requesting an additional level of resources if the resources threshold has been exceeded.

6. The method according to claim 1, wherein the resources are selected from the group comprising internet resources, network resources and server resources.

7. A method comprising:
identifying a need for improved Quality of Service (QoS) in certain areas of a network;
determining each user and group present in the network;
distributing and installing a QoS client;
installing at least one QoS rule based on a network requirement; and
generating a indication if the at least one QoS rule has been violated.

8. The method according to claim 7, wherein the at least one QoS rule is selected from the group comprising traffic rate, volume, time of day and approved websites.

9. The method according to claim 7, wherein the at least one QoS rules includes a resources threshold indicative of a maximum level of recommended resource consumption for the QoS client.

10. The method according to claim 9, further comprising monitoring a current level of resource consumption at the QoS client.

11. The method according to claim 10, further comprising notifying the QoS client if the current level of resource consumption is approaching the resources threshold

12. A system comprising:
a plurality of clients configured to communicate through at least one server, each client including a bandwidth threshold indicative of a maximum level of recommended resource consumption for each client; and
an indicator configured to notify the client if a current level of resource consumption at the client is approaching the bandwidth threshold.

13. The system according to claim 12, wherein the bandwidth threshold is indicative of a maximum level of recommended resource consumption for the plurality of clients and the current level of resource consumption includes the current level of resource consumption for the plurality of clients.

14. An article comprising a storage medium having stored thereon instructions that when executed by a machine result in the following:
establishing a resources threshold, the resources threshold indicative of a maximum level of recommended resource consumption for a client;
monitoring a level of resource consumption at the client; and
notifying the client if the level of resource consumption is approaching the resources threshold.

15. The article according to claim 14, wherein notifying the client is performed via an indicator associated with the client.

16. The article according to claim 14, further comprising generating an alert if the level of resource consumption exceeds the resources threshold.

17. The article according to claim 14, further comprising creating a profile for the client, the profile including security management data.

18. The article according to claim 14, further comprising requesting an additional level of resources if the resources threshold has been exceeded.

19. The article according to claim 14, wherein the resources are selected from the group comprising internet resources, network resources and server resources.
